(19) United States
(12) Patent Application Publication
(10) Pub. No.: US 2025/0160452 A1
(43) Pub. Date: May 22, 2025

(54) A SYSTEM FOR THE SUPPORTING AND THE CONTAINMENT OF AN INDIVIDUAL THROUGH AN INFLATABLE EXOSKELETON STRUCTURE

(71) Applicant: Francesco BOSCARINO, Rome (IT)

(72) Inventor: Francesco BOSCARINO, Rome (IT)

(21) Appl. No.: 18/839,005

(22) PCT Filed: Apr. 17, 2023
(86) PCT No.: PCT/IB2023/053930

§ 371 Date: Aug. 15, 2024

(30) Foreign Application Priority Data
Feb. 15, 2022 (IT) 102022000002759

(51) Int. Cl. A41D 13/012; B63C 9/105

(52) U.S. Cl. CPC A41D 13/0125; B63C 9/1055

(57) ABSTRACT

The present invention provides a system for the supporting and the containment of a person, which system comprises an inflatable exoskeleton structure, and an inflatable containment structure for said person. The exoskeleton structure is substantially soft and flexible when in the non-inflated condition and is easily worn by the user, and once worn it can be inflated for submersion in water to provide the required buoyancy support to the user. When the inflatable containment structure is in the deflated condition it is completely collapsed and may be contained in a bag or backpack, and when it is in the fully inflated condition it can accommodate and support the injured person therein in a blocked manner by containment means of said person in said containment structure.

### FIELD OF THE INVENTION

The following invention relates to the technical sector of exoskeletons and, more precisely, the present invention relates to a system for the supporting and the containment of an individual through a wearable inflatable exoskeleton structure capable of providing support and protection to an individual during certain activities.

### State of the Art

As already known in the art, a number of different exoskeletal solutions available in the market are used to increase the physical or structural strength of an individual, also used as a support and mobility devices for dystrophic disabilities or paralysis following to accidents, or for military or civilians uses.

Typically, such devices are built with rigid materials and are structured in complex and very expensive shapes, often combined with complex electronic systems. In fact, the known exoskeletons available in the market normally relate to external structures to the human body, which are fixedly connected to the individual with suitable supports, i.e. to the legs or arms, and having extraordinary and complex technological features.

The exoskeleton by its definition is a rigid external structure and performs the function of restoring or enhancing the movements of the individual who wears it.

Therefore, the main functions are to guarantee an ergonomic structure compatible with the wearer and to allow controlled and pre-established movements.

However, the aforementioned features have some limitations that make these exoskeletal structures unsuitable for certain uses, in some cases for daily use.

For example, in the case of a disabled person who needs to receive physiotherapy sessions in a swimming pool (for example, with loss of use of the legs and the abdominal/lumbar region following an accident), there are no suitable technical devices on the market that can support the person in a controlled and safe manner during the dive. In fact, the exoskeletal structures available on the market for disabled people allow the use thereof in limited spaces such as inside one's own home and with limited performance. Furthermore, the submersion in fact lightens the weight of the body, making such a rigid and robust exoskeletal structure superfluous, as well as being absolutely unsuitable for being submerged in water.

The exoskeletons available in the market are exclusive and expensive, highly technological devices and represent extraordinary engineering feats for the few. On the other hand, in the case of relief and rescue operations for people involved in accidents in hostile environments (such as mountain or marine activities), it is known the use of containment and stabilization structures for the injured person to allow the transportation thereof to an emergency unit. Such types of containment and stabilization structures typically include stretchers and the like. In fact, the present stretchers used in mountain or sea rescue are made of a rigid material and allow operators to transport a few devices at a time and above all difficult to transport the same in impervious situations.

### BRIEF DESCRIPTION OF THE INVENTION

The present invention provides to a system for the supporting and the containment of an individual, the system comprises an inflatable exoskeleton structure, an individual containment structure, the individual containment structure being inflatable, the containment structure comprising supporting means for the supporting of said containment structure, means for the transporting of the containment structure, and containment means for the containment of said person in said containment structure.

### Technical Problem

In all leisure or sporting activities it would be useful to have a device that can allow the user to swim freely in the sea or to train in the pool or as back support for canoeing.

Therefore, there is a need to provide an exoskeletal structure that can offer some essential exoskeletal characteristics intended for some simple daily activities required by the disabled person.

Furthermore, in the case of rescue and rescue operations of people involved in accidents in hostile environments (such as mountain or marine activities), there is a need to supply the market with a system which provides for the use of a containment and stabilization structure of an injured person following an accident in a hostile environment, which structure solves the aforementioned limitations for the use of such containment and stabilization structures of the state of the art.

### Solution of the Technical Problem

The present invention provides a system for the supporting and the containment of an individual, which system comprises an inflatable exoskeleton structure, and an inflatable person containment structure.

The exoskeleton structure is substantially soft and flexible when in the non-inflated condition and is easily worn by the user, and once worn it can be inflated for submersion in water to provide the required floating support to the user.

The inflatable containment structure when in the deflated condition is completely collapsed and is adapted to be contained in a small container element such as a bag or a backpack, and when in the fully inflated condition it is adapted to accommodate and support the injured person therein and being supported and contained therein, and wherein the containment structure comprises supporting means for the supporting of the said containment structure, transporting means for the transporting of the said containment structure, and containment means for the containing of said person within said containment structure.

### Advantageous Effects of the Invention

According to a first aspect of the present invention, the exoskeletal structure being wearable with extreme ease, allows the users to obtain the characteristic benefits of the exoskeletons.

According to a second aspect of the present invention, the inflatable exoskeletal structure allows the use thereof in water by the user, being transportable with extreme ease, and provides for an absolutely accessible cost for all users.

According to a third aspect of the present invention, the exoskeletal structure can be employed in circumstances otherwise impossible with respect to exoskeletal structures of the state of the art, such as water physiotherapy activities for disabled persons and the like.

According to a fourth aspect of the present invention, the inflatable supporting and containment structure in the deflated and collapsed condition can be easily carried by a user during outdoor or indoor sports activity in a suitable bag and, if necessary, can be easily used by the user himself or by other users.

### DESCRIPTION OF THE FIGURES

A detailed description of three preferred embodiments of the system of the present invention will now be provided, given by way of non-limiting example, with reference to the accompanying figures, wherein:

FIGS. 1A and 1B illustrate a front and rear elevations views, respectively, of an inflatable exoskeleton structure worn by an individual, according to a first embodiment of the containment and support system of the present invention;

FIG. 2 schematically illustrates a side elevation view of the inflatable exoskeleton structure of FIG. 1A when worn by an individual while submerged and swimming in water;

FIG. 3 schematically illustrates an elevation view of an individual wearing the inflatable exoskeleton structure of FIG. 1A submerged in water in an upright condition;

FIG. 4A schematically illustrates a top plan view of a containment structure according to a second embodiment of the system of the present invention in an inflated condition and wherein an individual is contained inside thereof;

FIG. 4B is a schematic bottom plan view of the containment structure of FIG. 4A according to the system of the present invention;

FIG. 5 is a schematic cross-sectional view of the containment structure of FIG. 4A according to the system of the present invention;

FIG. 6 is a schematic and partial side view and in a longitudinal section of the containment structure of FIG. 4A in a first operating condition thereof, and according to the system of the present invention;

FIG. 7 is a schematic and partial side view in longitudinal section of the containment structure of FIG. 6 in a second operating condition thereof;

FIG. 8 schematically and partially shows a third embodiment of the containment structure of the supporting and containment system of the present invention in a non-operative condition; and

FIG. 9 schematically and partially shows in a cross sectional view the containment structure of FIG. 8 of the supporting and containment system of the present invention.

### DETAILED DESCRIPTION OF THE PREFERRED EMBODIMENTS OF THE SYSTEM OF THE PRESENT INVENTION

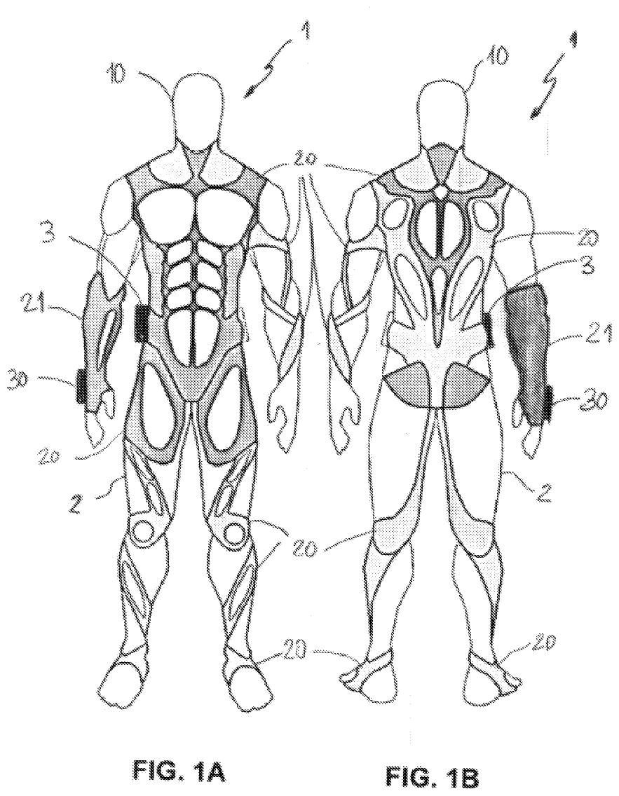

With reference now to FIGS. 1A, 1B, 2, and 3, an inflatable and wearable by a person exoskeleton structure according to a first embodiment of the supporting and containment system for an individual according to the present invention is illustrated.

According to the present invention an exoskeletal structure 1 is provided, the structure comprises a tight-fitting overall suit 2 to be worn on a person 10 and which has a plurality of inflatable regions 20 arranged over the entire surface of the overall suit 2 in the manner illustrated here below.

Each inflatable region 20 of the suit 2 is made using thin and soft bands of heat-sealed air chamber arranged onto the suit 2 following a specific and ergonomic design. More precisely, the arrangement of the inflatable regions 20 onto the suit 2 follows the natural muscular arrangement of the human body.

It should be noted that the set of inflatable regions 20 constitutes the variable stiffness part of the exoskeletal suit 2 itself, leaving uncovered all the parts of the body not involved in obtaining the required stiffness, for example the joints of the body, in order to form a rigid but not constrictive support.

With the present arrangement of the inflatable regions 20, the suit 2 allows a rapid outflow of water in case of submersion or recirculation of air in case of activities in the gym.

The inflatable regions 20 are made of a high resistance material, with the side in contact with the body made of a very thin layer of neoprene lined for optimal comfort, having a non-impregnating and quick drying feature.

The material constituting the walls of the regions 20 is preferably chosen from flexible materials typically for nautical use (such as, for example, sails or kite surf wings) in which a fabric with Kevlar or carbon filaments is typically used, and such as to ensure a high resistance to the inflatable region 20 and a considerable stiffness when the region 20 is subjected to air inflation pressure. Preferably, the pressure value varies between 0.3 bar and 0.9 bar.

It should be noted here that according to the present arrangement of the inflatable regions 20 onto the suit 2, it is possible to vary the volume of air contained therein according to the required performance. In fact, when the device is worn, its rigidity is zero, thus allowing all the necessary movements for the user before performing the performance/physiotherapy.

With the above aim, the suit 2 is integrally equipped with a control unit 3 positioned in a region of the suit 2 which is easy to access for the user, which is self-powered, and allows the control of devices mounted therein and for the inflating and the deflating of the volume of air to be introduced into the set of inflatable regions 20. For example, according to one embodiment, the inflating/deflating devices can be operated manually as simple pressure pumps. Alternatively, the inflating devices can be operated manually by means of buttons associated with pressure containers (such as small refillable compressed air cylinders of the already existing type), easily available in the market at a low cost. For the deflation, an air release button is provided which includes a manual valve equipped with a safety device against involuntary activation.

For operation, the person 10 decides when to activate the inflating control unit 3 and, advantageously, he can decide which portion or area of the suit 2 to inflate and thus obtain a localized stiffening of the same (by voluntarily setting a pressure value before or during the performance).

Only as a non-limiting example, four essential parts/regions that make up the inflatable exoskeleton structure can be indicated: a) torso; b) shoulders and neck; c) lower limbs; and d) arms.

### a) Torso

This region consists of a front and a back joined at the respective sides of the shoulder section. In this way, an arrangement of inflatable regions 20 is created which constitute a sort of “shell” structure which can be worn through the dedicated hole for the head and then fastened on the right and left sides of torso, respectively, under the armpit area using fasteners means such as VELCRO® or similar. Once this part has been fixed onto the person 10, it will result in a cage adhering to the body with the prerogative of being able to be adapted to any adjustments for better comfort.

### b) Shoulders and Neck

As can be seen in FIGS. 1A and 1B, this region is connected to the torso structure, and has as a feature a full covering neck areas as expected. These areas, in fact, will have a more consistent volume of air in order to be provide supporting buoyancy in a vertical position, and continuously guaranteeing the head out of the water. Advantageously, the inflatable structure 1 provides an upper inflation region 20 related to the cervical area of the person 10 who wears the same, which is essential for configuring an ergonomic accommodation for the head. In fact, the shape of the inflatable regions 20 provides for a series of different pressurised chambers that house and contain the neck region and keep the head in a correct position throughout the activity.

### c) Lower Limbs

The lower area of the exoskeletal structure 1, i.e. the one relating to the legs, features an helical pattern, which makes the exoskeletal structure 1 easy to put on and take off even during submersion of the individual. The exoskeletal structure 2 at the regions relating to the legs does not require particular rigidity after inflation, because it mainly performs the function of a controlled buoyancy to allow physiotherapy exercises to be carried out in the pool or to swim.

It should be noted here that the arrangement of the inflatable regions 20 at the legs region of the suit 2 is such as to wrap the legs in a helical pattern, so as to obtain a structure which prevents the knee joint from flexing when the inflatable regions 20 are at the right pressure, and to fully restore joint function when these regions 20 gradually deflate.

Furthermore, at the heel and instep region, the arrangement of the inflatable regions 20 is such as to leave the toes free and does not prevents the flow of water when leaving the water, nor constitutes a hydrodynamic resistance while swimming.

### d) Arms

FIGS. 1A and 1B show two alternative configuration arrangement of the inflatable exoskeleton structure 1 with respect to the arms. More precisely, according to a first configuration an inflatable structure 21 is provided which completely encases the forearm and has a control unit 30 associated with the structure 21. The structure 21 performs the function of extreme buoyancy during physiotherapy exercises in a swimming pool for the exclusively adjuvant use together with the exoskeletal structure 1 worn by the user; in fact, the buoyancy thrust of the structure 21 helps to give the user a greater safety during all the phases of physiotherapy. Alternatively, a distribution of inflatable regions 20 on the limb can be provided with an helical pattern in the manner above described, in order to give support to the limb without impeding its joint movement.

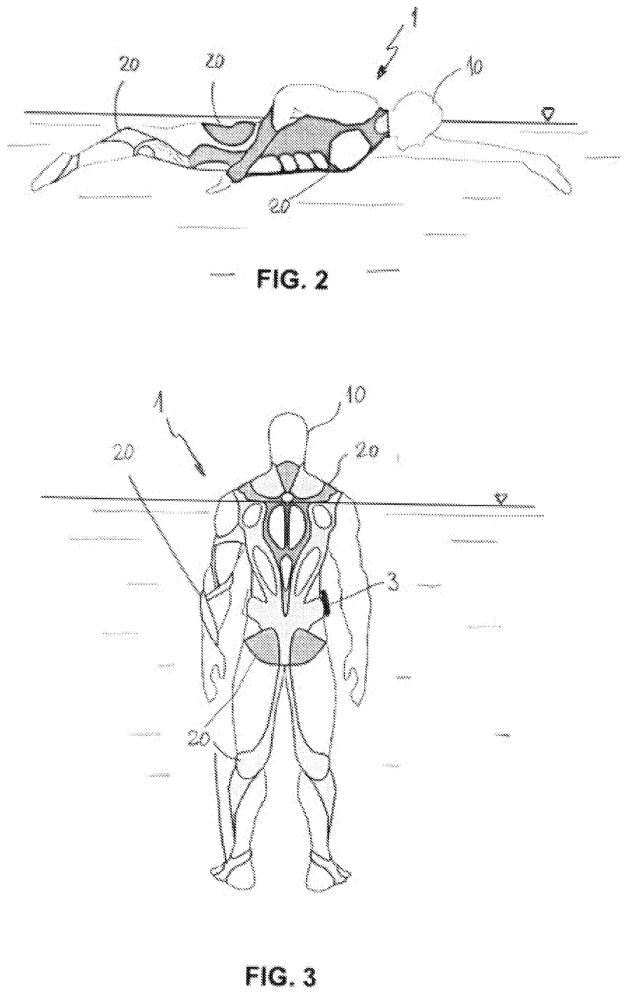

Referring now to FIG. 2, a person 10 using the exoskeleton structure 1 during the swimming is therein illustrated. In this condition, the configuration provides for maximum rigidity of the inflatable regions 20 at the abdominal area for the supporting of the legs of a disabled person 10 during swimming. Furthermore, if required, the inflation of the inflatable regions 20 at the legs can also be provided. In this way a buoyancy thrust towards the water surface is obtained and therefore a flotation in an horizontal position of the person, suitable for the required performance since the buoyancy obtained from this configuration is characterized by different thrust forces towards the surface and in order to control the submersion of the legs.

With particular reference now to FIG. 3, there is schematically illustrated in an elevational view a person 10 who wears the inflatable exoskeleton structure 1 immersed in water in a vertical condition. In this condition, the exoskeleton structure 1 is inflated in the torso and abdomen regions and the related rear region which performs postural support of the back, lumbar, and sacral regions. The inflatable regions 20 of this section of exoskeletal structure 1 have the feature of being independent one form each other and the relevant dedicated inflating/deflating devices which can be easily operated with one hand. In this way, the volume of air introduced into this region of the exoskeletal structure 1 allows the person 10 to be kept in a controlled submerged condition, keeping the individual head and shoulders above the water surface in a vertical position.

Furthermore, the upper part of the structure 1 comprises the shoulders, leaving the deltoid region free to allow a total mobility of the arm during the swimming. Furthermore, the cervical inflated extension supporting the head ensures that the latter remains above the water surface.

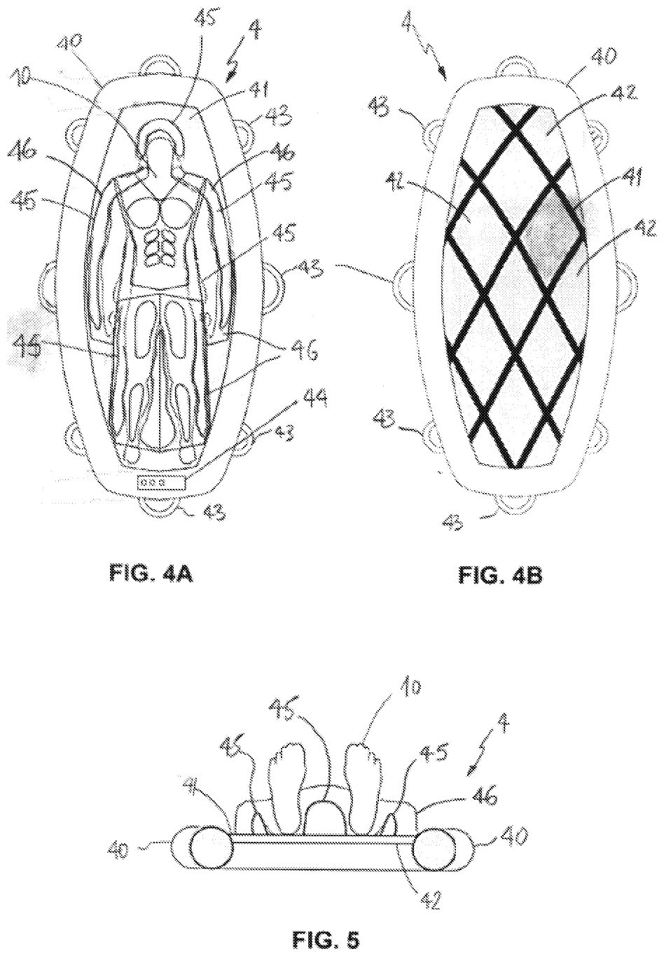

With reference now to FIGS. 4A, 4B, 5, 6 and 7, an embodiment of a containment structure is illustrated therein and which forms part of the system for the containment and the supporting of an individual according to the present invention.

It should be noted here that the present embodiment of the containment structure illustrated herein is particularly aimed at rescue operations as illustrated below.

According to this embodiment of the invention there is provided a containment structure 4 suitable for holding a person 10 in a contained and blocked manner inside the former. The containment structure 4 comprises an inflatable region 40 consisting of a flexible tubular chamber connected to a base region 41 which is also inflatable in separate compartments. As illustrated in FIG. 4B, the base 41 comprises a rigid part and an inflatable part layer 42 at the outer side intended to contact the external surface, the layer 42 being made with a very high resistance heat-sealed material configured with plates 42 made of a material suitable for the use described. The plates 42 internally house air chambers which, once inflated to the indicated pressure, provide a protective shield against shocks, while the base 41 is rigid enough to give the rescue structure the structural specifications required by the regulations.

The materials that make up the entire containment structure 4 are high-strength materials that guarantee sliding on uneven surfaces, gravel, snow, water, ice. Preferably, materials are chosen among the materials having mechanical features such as, for example, CORDURA® nylon reinforced with Kevlar filaments suitable for withstanding dragging and anti-puncture stress and for conferring functional rigidity to the structure 4.

Furthermore, the containment structure 4 comprises a series of handles 43 arranged around the perimeter of the chamber 40 to allow the lifting and transporting of the structure 4 by operators, which makes the structure 4 suitable to be transported or towed in case of rescue in sea or in the event of floods, or towed on snow or in the mountains.

Furthermore, a control unit 44 is provided mounted onto the tubular 40 and suitable for activating and controlling the automatic inflating of the air coming from a pressurized container integrally housed in the structure 4 (the latter not shown in the figures).

As illustrated in FIGS. 4A and 5, the surface 41 is provided with a plurality of protruding elements 45 which are inflatable and arranged such that, when inflated, they project outwardly from the surface 41. The arrangement and shape of the plurality of protruding elements 45 on the surface 41 is such that, once inflated, they define and circumscribe a region suitable for housing an injured person 10 inside it and for providing containment regions for the various parts of the body of the person 10. Furthermore, there is provided a pair of containing elements 46 which are removable and inflatable, and which reproduce an exoskeletal structure suitable for interfacing and cooperating with the plurality of protruding elements 45. The containing elements 46 are adapted to be arranged above the person 10 once the latter is placed onto the surface 41 and within the region defined by the elements 45, and to interact with the latter in such a way as to create a containing supporting shell structure for the person 10 housed therein.

It should be noted here that the previously described exoskeletal structure 1 is substantially and technically equivalent to the combination of the containment elements 45 and 46, even if the latter are intended for a different use than the former.

For the functioning of the system, the containment structure 4 is first deployed onto the surface at the proximity of the injured person 10. Then, the injured person 10 is first laid down onto the surface 41 of the containment structure 4 and within the circumscribed region by the protruding elements 45. Subsequently, the person 10 is covered by the containment elements 46 once inflated. Then, the elements 46 are fastened to the structure 4 by means of suitable fastening means (the latter not shown in the figures). The fastening means can be chosen from the group which includes VELCRO® or ZIP hinges or fastening elements located at the surface 41 and/or onto the tubular 40.

At this point, the containment structure 4 can be inflated by activating the control unit 44. Once the entire containment structure 4 has been inflated, the injured person 10 is ready to be transported in a stable manner and contained within the protective elements above described.

Optionally, the upper part of the structure 4 can include a thermal sheet to protect against the weather condition, fastened with a zip on the sides of the tubes 40.

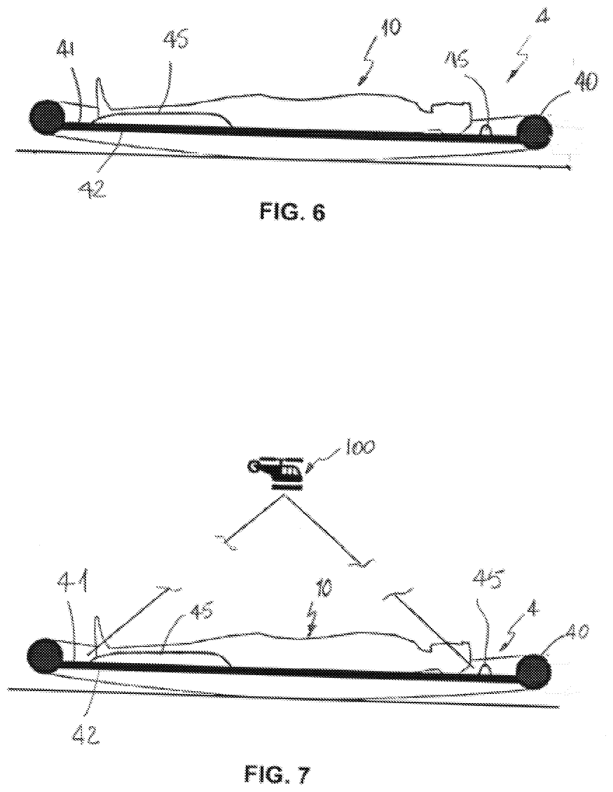

With reference now to FIGS. 6 and 7, a particular application of the supporting and containment system of the present invention is schematically illustrated therein.

As can be seen in the figures, in case of extreme rescue and after having arranged and blocked the injured person 10 onto the surface 41 of the containment structure 4 in the manner described above, it is possible to hook the structure 4 to an aircraft such as, for example, a helicopter 100, or a drone or similar in the manner already known, by means of the handles 43 or, alternatively, by means of suitable hooking elements located in the structure 4. According to this application, it is possible to transport an injured person 10 via the structure 4 with aerial means once it is hooked for vertical lifting by anchoring the appropriate straps supplied to the containment and supporting system of the present invention in a special bags container.

It should be noted here that the supporting and containment system of the present invention foresees features of lightness, stiffness, and dimensions when deflated (a bag of about 30 LT) which allow the same to be transported by a DRONE, allowing rescue operators to reach the injured person very quickly and without danger of the former. Advantageously, the supporting and containment system of the present invention can be launched from high altitudes, providing it with a floating acoustic and luminous signaler, and together with a first aid kit suitable for the case. Furthermore, the supporting and containment system of the present invention is reusable and easily washable.

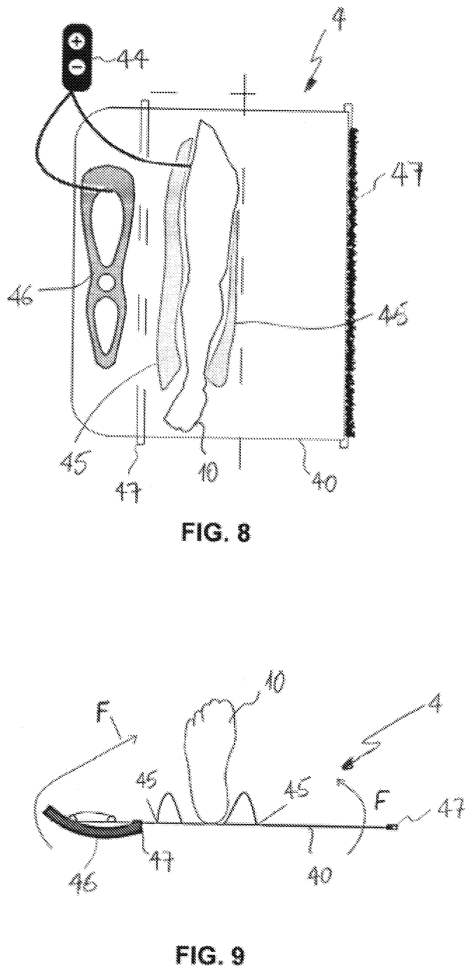

With reference now to FIGS. 8 and 9, a third embodiment of the supporting and containment system of the present invention is schematically and partially illustrated. For the sake of clarity, like parts will have like numbers, and the detailed description thereof will be omitted herein since already provided before.

According to this embodiment, the supporting and containment system comprises a containment structure 4 which includes an element 40 constituted by a mat-shaped flexible and elastic material, which is preferably made of an elasticized and micro-perforated material according to the state of the art. Protruding elements 45 which are inflatable are integrally arranged within this element 40. Once the protruding elements 45 have been inflated, they define a region of the mat which circumscribes the limb to be contained and supported by the injured person 10 according to a predefined position.

The element 40 is separated into two sections. The first section houses the protruding elements 45 where the injured limb is suitable to be placed therein on the element 40. The second section integrally presents a series of inflatable containment and protecting elements 46. The arrangement of the inflatable elements 46 on the element 40 is such as to constitute the part of the element 40 which is provided for immobilizing the relevant part of the injured limb.

Both the protruding elements 45 and the elements 46 are inflatable via an inflation and control unit 44 configured as previously described. The unit 44 is placed externally to the mat structure 4, pneumatically connecting to the same through flexible pipes and being fixedly connected to the element 40 by means of a removable locking means such as, for example, VELCRO®.

For the operation of the supporting and containment system according to the present embodiment, it is provided that the element 40 is first wrapped around the injured limb and as indicated by the arrows F of FIG. 9 with a simple wrapping manoeuvre. Therefore, the element 40 can be fixed positioned onto the limb by means of fixing and blocking means 47 (which in the present embodiment are represented by VELCRO®) in the manner already known in the art. Once the locking manoeuvre of the element 40 around the injured limb has been completed, the gradual inflation of the elements 45 and 46 is started via the control unit 44 until a rigid exoskeletal cell is created which contains and supports the injured limb but does not compress the latter, because the upper part of the mat element 40 rests on the lower part of the same, or more precisely the elements 46 rest onto the elements 45.

1. A system for the supporting and the containment of a person (10), the system being characterized by the fact that it includes:
a) an inflatable exoskeleton structure (1) wearable by said person (10), and
b) an inflatable structure (4) for the supporting and the containing of said person (10).

2. A system for the supporting and the containment of a person (10) according to the preceding claim, wherein said inflatable exoskeleton structure (1) comprises a close-fitting overalls (2) adapted to be worn by said person (10), said overalls (2) comprising a plurality of inflatable regions (20) by means of a gas supply such as air or the like, and being arranged on the entire surface of said suit (2), the arrangement of said inflatable regions (20) on said suit (2) being such that said regions (20) follow an ergonomic and anatomical arrangement.

3. A system for the supporting and the containment of a person (10) according to the preceding claim, wherein said inflatable regions (20) comprise band-shaped air chambers arranged onto said overalls (2) in an arrangement that follows the natural shape of the muscles of the human body.

4. A system for the supporting and the containment of a person (10) according to the preceding claim, wherein said inflatable regions (20) are made of a flexible material comprising a fabric with Kevlar® or carbon filaments, and such that each inflatable region (20) has a high resistance and a considerable rigidity when said region (20) is subjected at an internal inflation pressure.

5. A system for the supporting and the containment of a person (10) according to the preceding claim, wherein the value of said inflation pressure is comprised between 0.3 bar and 0.9 bar.

6. A system for the supporting and the containment of a person (10) according to any of the preceding claims 2-5, wherein said inflatable exoskeleton structure (1) comprises a control unit (3) at a preestablished region of said suit (2), said control unit (3) being self-powered, and capable of controlling respective inflating and deflating devices of a volume of gas to be introduced into said plurality of inflatable regions (20).

7. A system for the supporting and the containment of a person (10) according to the preceding claim, wherein said inflating/deflating devices are selected from the group comprising: manually operated inflating devices, inflating devices operated by means of pressurised containers, and manual deflation valves equipped with safety device against involuntary activation.

8. A system for the supporting and the containment of a person (10) according to any of the preceding claims 3-7, wherein said control unit (3) is configured to inflate said inflatable regions (20) selectively.

9. A system for the supporting and the containment of a person (10) according to any of the preceding claims 2-8, wherein said exoskeleton structure (1) is divided into four regions: a) torso; b) shoulders and neck; c) lower limbs; and d) arms.

10. A system for the supporting and the containment of a person (10) according to the preceding claim, wherein said torso region (a) is composed of a front part and a rear part, mutually joined at the respective sides of the shoulders section, the arrangement being such that a “shell” structure of a plurality of inflatable regions (20) is provided which is able to be fastened on the right and left sides, respectively, under the armpit region by means of fastening means such as VELCRO® or similar, said shell structure once fixed onto said person (10) constitutes a casing adhering to the body.

11. A system for the supporting and the containment of a person (10) according to claim 9 or 10, wherein said shoulder and neck region (b) is connected to said torso region (a), and further comprises an upper inflating region (20) related to the cervical area of said person (10), and such that as to provide an ergonomic accommodation for the head and containment of the neck, such as to keep said head in a correct position throughout the activity.

12. A system for the supporting and the containment of a person (10) according to claim 9 or 10 or 11, wherein said lower limbs region (c) comprises a plurality of inflatable regions (20) arranged in a helical pattern enveloping each limb, and such as to obtain an inflated structure which prevents the knee joint from flexing when said inflatable regions (20) are inflated, and such as to fully restore the knee joint function when said regions (20) are deflated, and such that at the heel and instep region of each foot, the arrangement of said inflatable regions (20) is such as to leave the toes free.

13. A system for the supporting and the containment of a person (10) according to claim 9 or 10 or 11 or 12, wherein said arms region (d) comprises an inflatable structure (21) which encloses the forearm completely, and comprises a control unit (30) associated with the structure (21), or alternatively comprises a distribution of inflatable regions (20) on the upper limb according to a helical pattern which wraps around said upper limb.

14. A system for the supporting and the containment of a person (10) according to claim 1, wherein said inflatable structure (4) for supporting and containing said person (10) comprises:
a) an inflatable region (40) having an annular shape and consisting of a flexible tubular chamber;
b) a base region (41) having an upper surface suitable for housing said person (10), said base region (41) having a rigid part and an inflatable part with separate compartments and is connected perimetrically to said inflatable region (40), said base region (41) at the outer surface comprises an inflatable layer (42) with a very high surface resistance and configured in a plurality of plates (42);
c) a series of handles (43) perimetrically arranged to said annular tubular region (40) for allowing the raising and the transporting of the the structure (4);
and
d) a control unit (44) mounted on said tubular region (40) configured for the power and the control of the inflating of a gas inside said containment structure (4), said gas being contained in an integral pressurized container to said structure (4).

15. A system for the supporting and the containment of a person (10) according to the preceding claim, wherein said inflatable supporting and containment structure (4) is made of high-strength materials such as nylon CORDURA® reinforced with Kevlar filaments or the like.

16. A system for the supporting and the containment of a person (10) according to claim 14 or 15, wherein said containment structure (4) comprises:
a) a plurality of protruding elements (45) integrally arranged onto said surface (41) each of which being inflatable, and such that once inflated each of which protrude towards the outside of said surface (41), the arrangement and conformation of the plurality of protruding elements (45) on the surface (41) is such that once inflated they define and circumscribe a region suitable for the housing of said person (10) inside it and providing containment regions for the different parts of the body of said person (10);
and
b) at least one pair of removable and inflatable containment elements (46), and which reproduce an exoskeletal structure for interfacing and cooperating with said plurality of protruding elements (45), said containment elements (46) being configured to be placed over said person (10) once the latter is placed onto said surface (41) and within the region defined by said elements (45), and to interface with the latter in such a way as to create a containment supporting structure for said person (10) housed therein.

17. A system for the supporting and the containment of a person (10) according to the preceding claim, wherein said containment structure (4) comprises fastening means for fasten said elements (46) onto said structure (4), said fastening means being selected in the group that includes VELCRO®, ZIP hinges, fastening elements positioned on the surface (41) and/or on the tubular (40).

18. A system for the supporting and the containment of a person (10) according to any of claims 14-17, wherein said containment structure (4) further comprises a thermal sheet for the protection against the weather, fastened with a zip at each side of the tubular (40).

19. A system for the supporting and the containment of a person (10) according to any of claims 14-18, wherein said containment structure (4) further comprises hooking means for air transport with an aircraft such as a helicopter (100), a drone, or the like, said hooking means comprising hooking elements located in said structure (4) and a plurality of belts supplied together with the containment and supporting system.

20. A system for the supporting and the containment of a person (10) according to claim 1, wherein said containment structure (4) comprises:
a) an element (40) made of a mat-shaped flexible and elastic material;
b) a plurality of protruding inflatable elements (45) and integrally housed within said element (40), said plurality of protruding elements (45) defining a region in said mat element (40) which circumscribes a predefined position for a limb of said person (10) to be contained and supported therein.

21. A system for the supporting and the containment of a person (10) according to the preceding claim, wherein said element (40) has two sections, wherein the first section houses said protruding elements (45) where said limb has to be placed on said mat element (40), and wherein the second section integrally comprises a series of inflatable elements (46) for the containment and the protection, the arrangement of the inflatable elements (46) on the mat element (40) is such as to constitute the part of the mat element (40) for the blocking of an injured part of the limb.

22. A system for the supporting and the containment of a person (10) according to the preceding claim, wherein both the protruding elements (45) and the elements (46) are inflatable by means of an inflating and control unit (44), said unit (44) being externally mounted to said structure (4), and connected to the same through flexible pipes and being fastened to said mat element (40) by means of removable fastening means such as, for example, VELCRO®.

23. A system for the supporting and the containment of a person (10) according to claim 21 or 22, wherein said mat element (40) is configured to be wrapped around said limb and fixed therein by means of fastening and blocking means (47), the arrangement being such that following the inflation of the elements (45) and (46) a substantially rigid exoskeletal shell is formed which contains and supports said limb part without compressing the latter and such that said elements (46) rest onto said elements (45).
